(19) United States
(12) Patent Application Publication
(10) Pub. No.: US 2026/0321514 A1
(43) Pub. Date: Oct. 15, 2026

(54) FILM CAPACITOR AND METHOD FOR MANUFACTURING THE SAME, METALIZED FILM RAW MATERIAL WOUND BODY AND METHOD FOR MANUFACTURING THE SAME, AND CONTAINER-ENCLOSED METALIZED FILM RAW MATERIAL WOUND BODY AND METHOD FOR MANUFACTURING THE SAME

(71) Applicant: Panasonic Intellectual Property Management Co., Ltd., Osaka (JP)

(72) Inventors: HIROKI TAKEOKA, Nara (JP); SYOUGO OGAWA, Toyama (JP)

(21) Appl. No.: 19/553,930

(22) Filed: Mar. 2, 2026

(30) Foreign Application Priority Data
Apr. 14, 2025 (JP) 2025-066402

(51) Int. Cl. H01G 4/33; H01G 2/12; H01G 4/14; H01G 4/32

(52) U.S. Cl. CPC H01G 4/33; H01G 2/12; H01G 4/14; H01G 4/32

(57) ABSTRACT

A film capacitor includes a first metalized film and a second metalized film. The first metalized film includes a first dielectric film, a first metal film disposed on the first dielectric film, and a first natural oxide film disposed on the first metal film. The second metalized film includes a second dielectric film, a second metal film disposed on the second dielectric film, and a second natural oxide film disposed on the second metal film. The thickness of the first natural oxide film is equal to the thickness of the second natural oxide film.

### BACKGROUND

### 1. Technical Field

The present disclosure generally relates to a film capacitor and a method for manufacturing the same, a metalized film raw material wound body and a method for manufacturing the same, and a container-enclosed metalized film raw material wound body and a method for manufacturing the same. More specifically, the present disclosure relates to a film capacitor including a metalized film and a method for manufacturing the same, a metalized film raw material wound body and a method for manufacturing the same, and a container-enclosed metalized film raw material wound body and a method for manufacturing the same.

### 2. Description of the Related Art

Unexamined Japanese Patent Publication No. 2007-080907 discloses a metalized film capacitor. In this metalized film capacitor, a metalized film is used that includes a vapor-deposited metal film on one surface of a dielectric film and further includes an oil film on the vapor-deposited metal film.

### SUMMARY

A film capacitor according to one aspect of the present disclosure includes a first metalized film and a second metalized film. The first metalized film includes a first dielectric film, a first metal film disposed on the first dielectric film, and a first natural oxide film disposed on the first metal film. The second metalized film includes a second dielectric film, a second metal film disposed on the second dielectric film, and a second natural oxide film disposed on the second metal film. A thickness of the first natural oxide film is equal to a thickness of the second natural oxide film.

A metalized film raw material wound body according to one aspect of the present disclosure is a metalized film raw material wound body that includes a metalized film raw material having a strip shape and being wound to form the metalized film raw material wound body. The metalized film raw material includes a dielectric film raw material having a strip shape and a plurality of metal films disposed on the dielectric film raw material to be arranged side by side in a width direction of the dielectric film raw material, the plurality of metal films each having a predetermined pattern. A protective agent is applied to both side parts or one side part of an entirety of the plurality of metal films each having the predetermined pattern in the width direction of the metalized film raw material.

A metalized film raw material wound body according to one aspect of the present disclosure is a metalized film raw material wound body that includes a metalized film raw material having a strip shape and being wound to form the metalized film raw material wound body. The metalized film raw material includes a dielectric film raw material having a strip shape and a plurality of metal films disposed on the dielectric film raw material to be arranged side by side in a width direction of the dielectric film raw material, the plurality of metal films each having a predetermined pattern. A protective agent is applied to both side end surfaces or one side end surface of the metalized film raw material wound body.

A container-enclosed metalized film raw material wound body according to one aspect of the present disclosure includes: a metalized film raw material wound body that includes a metalized film raw material having a strip shape and being wound to form the metalized film raw material wound body; and a container that houses the metalized film raw material wound body. The metalized film raw material includes a dielectric film raw material having a strip shape and a plurality of metal films disposed on the dielectric film raw material to be arranged side by side in a width direction of the dielectric film raw material, the plurality of metal films each having a predetermined pattern.

A method for manufacturing a metalized film raw material wound body according to one aspect of the present disclosure includes: a step of preparing a dielectric film raw material having a strip shape; a step of forming a metalized film raw material by disposing a plurality of metal films each having a predetermined pattern on one surface or both surfaces of the dielectric film raw material, the plurality of metal films being arranged side by side in a width direction of the dielectric film raw material; a step of applying a protective agent to both side parts or one side part of an entirety of the plurality of metal films each having the predetermined pattern in the width direction of the metalized film raw material; and a step of winding the metalized film raw material.

A method for manufacturing a metalized film raw material wound body according to one aspect of the present disclosure includes: a step of preparing a dielectric film raw material having a strip shape; a step of forming a metalized film raw material by disposing a plurality of metal films each having a predetermined pattern on one surface or both surfaces of the dielectric film raw material, the plurality of metal films being arranged side by side in a width direction of the dielectric film raw material; a step of winding the metalized film raw material to obtain a metalized film raw material wound body; and a step of applying a protective agent to both side end surfaces or one side end surface of the metalized film raw material wound body.

A method for manufacturing a container-enclosed metalized film raw material wound body according to one aspect of the present disclosure includes: a step of preparing a dielectric film raw material having a strip shape; a step of forming a metalized film raw material by disposing a plurality of metal films each having a predetermined pattern on one surface or both surfaces of the dielectric film raw material, the plurality of metal films being arranged side by side in a width direction of the dielectric film raw material; a step of winding the metalized film raw material to obtain a metalized film raw material wound body; and a step of housing the metalized film raw material wound body in a container.

A method for manufacturing a film capacitor according to one aspect of the present disclosure includes: a step of obtaining a plurality of metalized films by dividing the metalized film raw material for each of the plurality of metal films each having the predetermined pattern, the metalized film raw material being included in the metalized film raw material wound body or the container-enclosed metalized film raw material wound body; and a step of winding a pair of metalized films among the plurality of metalized films so that the pair of metalized films overlap each other.

According to the present disclosure, it is possible to suppress local electric field concentration and enhance reliability.

### BRIEF DESCRIPTION OF THE DRAWINGS

FIG. 1 is a schematic cross-sectional view illustrating a film capacitor according to first to third exemplary embodiments;

FIG. 2 is a schematic perspective view illustrating a manufacturing process of a wound body to be used in the film capacitor according to the first to the third exemplary embodiments;

FIG. 3 is a schematic perspective view illustrating the film capacitor according to the first to the third exemplary embodiments;

FIG. 4 is a schematic plan view illustrating a metalized film raw material to be used for manufacturing the film capacitor according to the first to the third exemplary embodiments;

FIG. 5 is a schematic perspective view illustrating a metalized film raw material wound body according to the first exemplary embodiment;

FIG. 6 is a flowchart illustrating a method for manufacturing the metalized film raw material wound body according to the first exemplary embodiment;

FIG. 7 is a schematic perspective view illustrating a metalized film raw material wound body according to the second exemplary embodiment;

FIG. 8 is a flowchart illustrating a method for manufacturing the metalized film raw material wound body according to the second exemplary embodiment;

FIG. 9 is a schematic perspective view illustrating a container-enclosed metalized film raw material wound body according to a third exemplary embodiment; and

FIG. 10 is a flowchart illustrating a method for manufacturing a container-enclosed metalized film raw material wound body according to the third exemplary embodiment.

### DETAILED DESCRIPTIONS OF EMBODIMENTS

Hereinafter, problems of the prior art will be briefly described.

In the metalized film capacitor of Unexamined Japanese Patent Publication No. 2007-080907, when an oil film is formed on a vapor-deposited metal film, the film thickness of the oil film may vary. As described above, when the film thickness of the oil film varies, the degree of natural oxidation of the vapor-deposited metal film also varies. Then, local electric field concentration may occur. For this reason, the metalized film capacitor of Unexamined Japanese Patent Publication No. 2007-080907 has a problem in which reliability may be deteriorated.

The present disclosure provides a film capacitor capable of suppressing local electric field concentration and enhancing reliability and a method for manufacturing the same, a metalized film raw material wound body and a method for manufacturing the same, and a container-enclosed metalized film raw material wound body and a method for manufacturing the same.

### 1. Overview

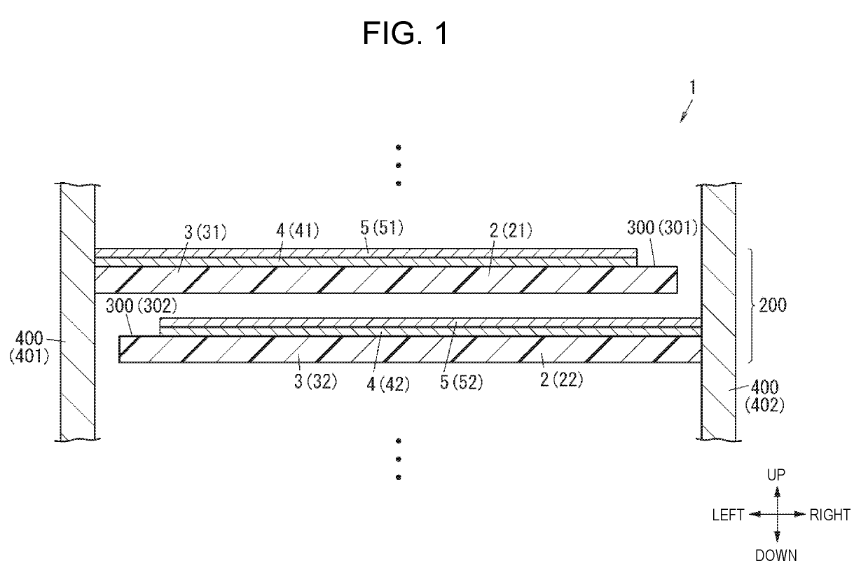

Hereinafter, film capacitor 1 according to the present exemplary embodiment will be described with reference to FIGS. 1-3. Each drawing is a schematic view, and a ratio of a size and a thickness of each component in each drawing does not necessarily reflect an actual dimensional ratio.

An arrow indicating each direction in each drawing is not intended to define a direction of film capacitor 1 at the time of use, but is merely written for easy understanding of the description, and is not accompanied by entity.

In FIG. 1, an up-and-down direction, a left-right direction, and a front-rear direction are defined.

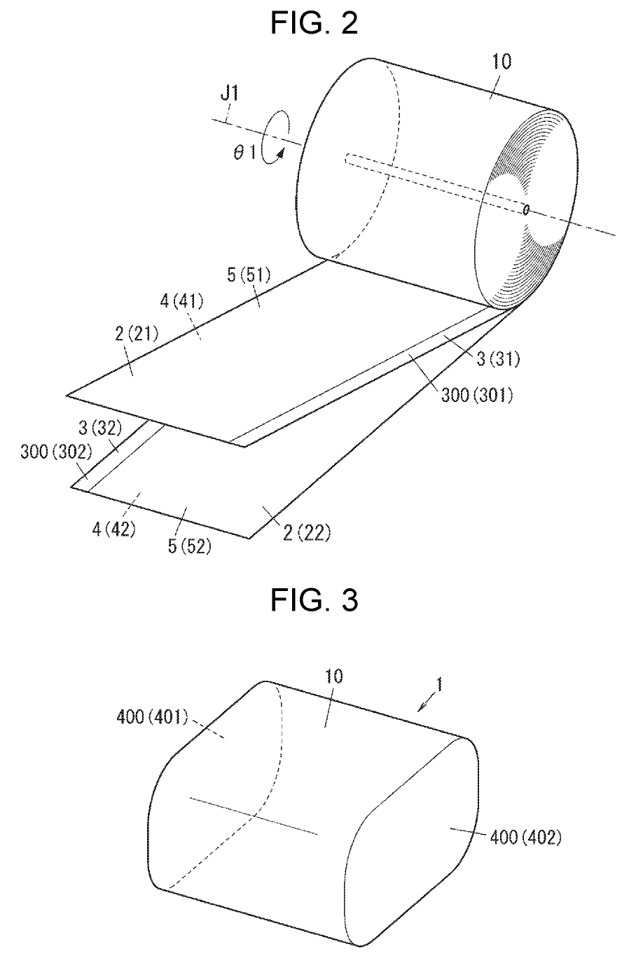

The up-and-down direction is a thickness direction of metalized film 2 (first metalized film 21 and second metalized film 22). When film capacitor 1 is a so-called wound type, the up-and-down direction in FIG. 1 corresponds to the radial direction of a virtual circle centered on the axis J1 in FIG. 2. Film capacitor 1 may be a so-called laminated type.

The left-right direction is a width direction of metalized film 2. The left-right direction in FIG. 1 corresponds to a direction parallel to the axis J1 in FIG. 2.

The front-rear direction is a direction orthogonal to the up-and-down direction and the left-right direction. That is, the front-rear direction is a direction orthogonal to the paper surface of FIG. 1. The front-rear direction in FIG. 1 corresponds to the circumferential direction θ1 in FIG. 2 or a tangential direction of the circumferential direction θ1 in a case where film capacitor 1 is a so-called wound type.

As illustrated in FIG. 1, film capacitor 1 according to the present exemplary embodiment includes metalized film 2, and end-face electrodes 400 (first end-face electrode 401 and second end-face electrode 402). Plurality of combinations 200 each including first metalized film 21 and second metalized film 22 may be stacked on top of each other in the up-and-down direction.

In FIG. 1, first metalized film 21 and second metalized film 22 are illustrated so as to be separated from each other in the up-and-down direction for easy understanding of the description, but actually first metalized film 21 and second metalized film 22 are in contact with each other in the up-and-down direction. Specifically, first dielectric film 31 of first metalized film 21 and second natural oxide film 52 of second metalized film 22 are in contact with each other in the up-and-down direction. Although not illustrated in FIG. 1, first natural oxide film 51 of first metalized film 21 and second dielectric film 32 of second metalized film 22 are in contact with each other in the up-and-down direction.

As described above, film capacitor 1 according to the present exemplary embodiment includes first metalized film 21 and second metalized film 22.

First metalized film 21 includes first dielectric film 31, first metal film 41 disposed on first dielectric film 31, and first natural oxide film 51 disposed on first metal film 41.

On the other hand, second metalized film 22 includes second dielectric film 32, second metal film 42 disposed on second dielectric film 32, and second natural oxide film 52 disposed on second metal film 42.

Here, natural oxide films 5 (first natural oxide film 51 and second natural oxide film 52) are thin films of oxide that are naturally formed when the surface layers of metal films 4 (first metal film 41 and second metal film 42) are exposed to the atmospheric air.

As described above, since each natural oxide film 5 is formed spontaneously without any special treatment, the thickness of first natural oxide film 51 is equal to the thickness of second natural oxide film 52. This reduces variation in thickness of dielectric film 3 and natural oxide film 5 sandwiched between first metal film 41 and second metal film 42. In the present specification, "the thickness of first natural oxide film 51 is equal to the thickness of second natural oxide film 52" means that the difference between the thickness of first natural oxide film 51 and the thickness of second natural oxide film 52 is within 10% of the thickness of first natural oxide film 51.

Therefore, according to film capacitor 1 of the present exemplary embodiment, local electric field concentration can be suppressed, and reliability can be enhanced.

### 2. Details

### 1 First exemplary embodiment

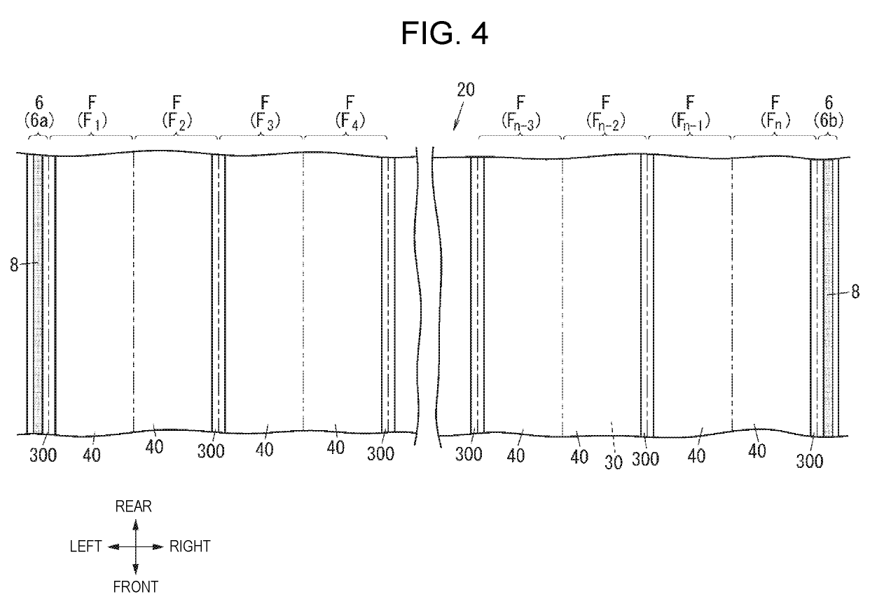

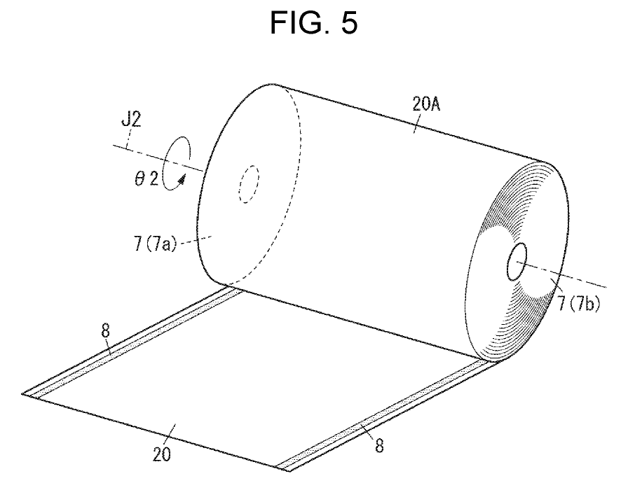

(1.1) Metalized film raw material wound body First, metalized film raw material wound body 20A according to the first exemplary embodiment will be described with reference to FIGS. 4 and 5. Each drawing is a schematic view, and a ratio of a size and a thickness of each component in each drawing does not necessarily reflect an actual dimensional ratio. The arrow indicating each direction in each drawing is merely written for easy understanding of the description, and is not accompanied by entity.

Metalized film raw material wound body 20A illustrated in FIG. 5 is used for manufacturing film capacitor 1. Metalized film raw material wound body 20A is formed by winding the metalized film raw material 20.

Metalized film raw material 20 is illustrated in FIG. 4. In FIG. 4, the front-rear direction, the left-right direction, and the up-and-down direction are defined.

The front-rear direction is a longitudinal direction of metalized film raw material 20. The front-rear direction in FIG. 4 corresponds to circumferential direction θ2 or a tangential direction of circumferential direction θ2 in metalized film raw material wound body 20A illustrated in FIG. 5.

The left-right direction is a width direction of metalized film raw material 20. The left-right direction in FIG. 4 corresponds to a direction parallel to the axis J2 in metalized film raw material wound body 20A illustrated in FIG. 5.

The up-and-down direction is a thickness direction of metalized film raw material 20. The up-and-down direction in FIG. 4 is a direction orthogonal to the front-rear direction and the left-right direction. That is, the up-and-down direction is a direction orthogonal to the paper surface of FIG. 4. The up-and-down direction in FIG. 4 corresponds to a radial direction of a virtual circle centered on axis J2 in metalized film raw material wound body 20A illustrated in FIG. 5.

Metalized film raw material

Metalized film raw material 20 has a strip shape. As illustrated in FIG. 4, metalized film raw material 20 includes dielectric film raw material 30, plurality of metal films 40 each having a predetermined pattern, and protective agent 8. Metalized film raw material 20 illustrated in FIG. 5 is illustrated in a simplified manner.

Dielectric film raw material

Dielectric film raw material 30 has a strip shape. The longitudinal direction of dielectric film raw material 30 coincides with the longitudinal direction of metalized film raw material 20.

The material of the dielectric film raw material 30 is not particularly limited, and examples thereof include polypropylene (PP), polyethylene terephthalate (PET), polyethylene naphthalate (PEN), polyphenylene sulfide (PPS), polycarbonate (PC), and polystyrene (PS).

The thickness of dielectric film raw material 30 is not particularly limited, and is, for example, 1 μm or more and 10 μm or less.

As illustrated in FIG. 4, dielectric film raw material 30 includes at least one pattern region F and at least one end region 6. In the first exemplary embodiment, the description will be given assuming that the number of pattern regions F is n (n is an integer of 2 or more) and the number of end regions 6 is two.

### Pattern region

Pattern regions F are each a region where metal film 40 having a predetermined pattern to be described later is formed. That is, the pattern regions F correspond to metal films 40 each having the predetermined pattern on a one-to-one basis.

The n pattern regions F are arranged in the width direction (left-right direction) of dielectric film raw material 30. Here, the n pattern regions F are set as a first pattern region F₁, second pattern regions F₂, ···, an (n-1)-th pattern region Fₙ₋₁, and an n-th pattern region Fₙ in order from left to right. That is, among the n pattern regions F, the leftmost pattern region F is first pattern region F₁, and the rightmost pattern region F is n-th pattern region Fₙ. The n pattern regions F extend in the longitudinal direction (front-rear direction).

In FIG. 4, a boundary line between two pattern regions F adjacent in the width direction is indicated by a two-dot chain line. As will be described again in the section of "(1.4) Method for Manufacturing Film Capacitor" described later, plurality (n) of metalized films 2 are obtained by cutting and dividing metalized film raw material 20 at the above-described boundary lines. Thus, pattern regions F correspond to metalized films 2 on a one-to-one basis.

### End Region

End region 6 is a region to which protective agent 8 described later is applied. End region 6 is located on both side parts or one side part (here, both side parts) of the entirety of n pattern regions F. In the first exemplary embodiment, the two end regions 6 are a left end region 6a and a right end region 6b. In each end region 6, metal film 40 having the predetermined pattern to be described later is not formed, but another metal film (hereinafter, also referred to as an "excess metal film") may be formed.

The left end region 6a is located at the left side of the first pattern region F₁ and extends in the front-rear direction. In FIG. 4, a boundary line between the left end region 6a and the first pattern region F₁ adjacent to each other in the width direction is indicated by a two-dot chain line.

On the other hand, the right end region 6b is located at the right side of the n-th pattern region Fₙ and extends in the front-rear direction. In FIG. 4, a boundary line between the n-th pattern region Fₙ and the right end region 6b adjacent in the width direction is indicated by a two-dot chain line.

As will be described again in the section of "(1.4) Method for Manufacturing Film Capacitor" described later, when metalized film raw material 20 is cut along the above-mentioned boundary lines, end regions 6 which is unnecessary for manufacturing film capacitor 1 can be removed.

### Metal film having predetermined pattern

Metal film 40 having the predetermined pattern is formed for each pattern region F. That is, metal films 40 each having the predetermined pattern correspond to the pattern regions F on a one-to-one basis. As described above, plurality (n) of metal films 40 each having the predetermined pattern are disposed to be arranged side by side in the width direction of dielectric film raw material 30.

In the first exemplary embodiment, metal films 40 each having the predetermined pattern continuously extend in the front-rear direction. The margin 300 is present at the left side or the right side of each metal film 40 having the predetermined pattern. In other words, the margin 300 is present at one end (left end or right end) in the width direction for each pattern region F. Each margin 300 is a portion where metal film 40 is not formed, and is a portion where dielectric film raw material 30 is exposed. The margin 300 extends in the front-rear direction.

Here, metal films 40 each having the predetermined pattern are not limited to those continuously extending in the front-rear direction. Examples of other patterns of metal films 40 include patterns described in Unexamined Japanese Patent Publication No. 2004-134561, Unexamined Japanese Patent Publication No. H2-033910, and Unexamined Japanese Utility Model Publication No. H3-101508.

Metal films 40 are formed by vapor deposition such as vacuum vapor deposition, for example. The material of metal films 40 is not particularly limited, and examples thereof include aluminum (Al), gold (Au), magnesium (Mg), zinc (Zn), tin (Sn), nickel (Ni), chromium (Cr), iron (Fe), copper (Cu), titanium (Ti), and alloys thereof.

The thickness of each metal film 40 is not particularly limited, but is, for example, 5 nm or more and 30 nm or less.

Protective agent

Protective agent 8 is used for preventing atmospheric air and moisture from entering the inside of metalized film raw material wound body 20A, and for protecting metal films 40 inside metalized film raw material wound body 20A from atmospheric air and moisture.

Protective agent 8 is not particularly limited, and examples thereof include silicon-based oil and fluorine-based oil. Protective agent 8 may be other than oil as long as it hardly allows the atmospheric air and moisture to pass therethrough.

Protective agent 8 is applied to both side parts or one side part (here, both side parts) of the entirety of the plurality (n) of metal films 40 each having the predetermined pattern in the width direction of metalized film raw material 20. Specifically, in the first exemplary embodiment, protective agent 8 is applied to end regions 6. In a case where no excess metal film is formed in end regions 6, protective agent 8 is directly applied to dielectric film raw material 30. On the other hand, in a case where an excess metal film is formed in end regions 6, protective agent 8 is indirectly applied to dielectric film raw material 30 via the excess metal films.

Protective agent 8 extends in the front-rear direction in end regions 6. Protective agent 8 is thus placed in a spiral shape in circumferential direction θ2 near end surfaces 7 (left end surface 7a and right end surface 7b) of metalized film raw material wound body 20A illustrated in FIG. 5. In FIG. 5, part of metalized film raw material 20 is unwound from metalized film raw material wound body 20A for convenience of description.

### Effects

According to metalized film raw material wound body 20A of the first exemplary embodiment, protective agent 8 functions as a breakwater in a sense, so that atmospheric air and moisture hardly enter the inside of metalized film raw material wound body 20A.

Here, in metalized film raw material wound body 20A, the end surfaces 7 can be entry paths of atmospheric air and moisture. In the first exemplary embodiment, protective agent 8 is placed in a spiral shape in circumferential direction θ2 near end surfaces 7 (left end surface 7a and right end surface 7b) of metalized film raw material wound body 20A. This makes it possible to prevent atmospheric air and moisture from entering the inside of metalized film raw material wound body 20A.

When protective agent 8 is absent, oxidation of the end portions is more likely to progress than that of the inside of metalized film raw material wound body 20A. In this way, uneven oxidation is promoted. For example, in FIG. 4, metal films 40 of first pattern region F₁ and n-th pattern region Fₙ are likely to be oxidized, and metal films 40 of fourth pattern region F₄ and (n-3)-th pattern region Fₙ₋₃ are hardly oxidized.

On the other hand, in the first exemplary embodiment, since protective agent 8 is present, natural oxidation can be promoted. For example, in FIG. 4, metal films 40 from first pattern region F₁ to n-th pattern region Fₙ are uniformly naturally oxidized. Therefore, quality of the plurality of plurality (n) of metalized films 2 becomes uniform.

Accordingly, variations in quality such as electrostatic capacity can be reduced in film capacitor 1 manufactured using metalized film raw material wound body 20A according to the first exemplary embodiment.

(1.2) Method for manufacturing metalized film raw material wound body

Next, a method for manufacturing metalized film raw material wound body 20A according to the first exemplary embodiment will be described with reference to FIGS. 4 to 6.

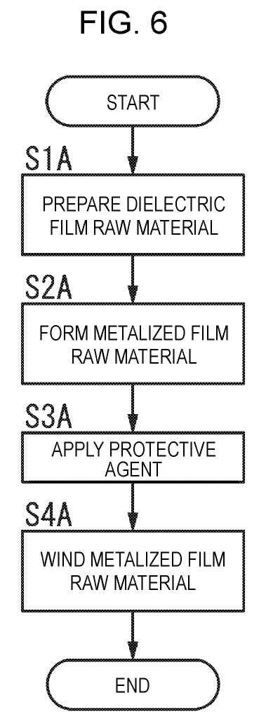

As illustrated in FIG. 6, the method for manufacturing metalized film raw material wound body 20A includes step S1A, step S2A, step S3A, and step S4A. A series of operations from step S1A to step S4A can be performed in a chamber.

S1A: preparation of dielectric film raw material

In step S1A, strip-shaped dielectric film raw material 30 is prepared. Dielectric film raw material 30 is, for example, wound and placed in a chamber as a wound body.

S2A: formation of metalized film raw material

In step S2A, metalized film raw material 20 illustrated in FIG. 4 is formed. Specifically, metal is vapor-deposited on dielectric film raw material 30 while dielectric film raw material 30 is unwound from the wound body of dielectric film raw material 30 in the chamber in which the inside thereof is evacuated. In this way, the plurality (n) of metal films 40 each having the predetermined pattern are disposed on one surface or both surfaces (here, one surface) of dielectric film raw material 30. Metalized film raw material 20 is thus formed. As described above, the plurality (n) of metal films 40 each having the predetermined pattern are arranged side by side in the width direction of dielectric film raw material 30.

The formed metalized film raw material 20 is once wound and then placed as a wound body in the evacuated chamber.

S3A: application of protective agent

In step S3A, protective agent 8 is applied to metalized film raw material 20. Specifically, protective agent 8 is applied to end regions 6 of metalized film raw material 20 while metalized film raw material 20 is unwound from a wound body of metalized film raw material 20 in the evacuated chamber. Protective agent 8 can be applied by, for example, spraying using a nozzle. Protective agent 8 is thus applied to both side parts or one side part (here, both side parts) of the entirety of the plurality (n) of metal films 40 each having the predetermined pattern in the width direction of metalized film raw material 20.

In the flowchart illustrated in FIG. 6, the operation of step S3A is performed after the operation of step S2A. However, the method for manufacturing metalized film raw material wound body 20A according to the first exemplary embodiment includes concurrently performing the operations of step S2A and step S3A. That is, the method for manufacturing metalized film raw material wound body 20A according to the first exemplary embodiment includes applying protective agent 8 while depositing metal on dielectric film raw material 30 through vapor deposition. As described above, if protective agent 8 is applied without waiting for the completion of all the vapor deposition operation of the metal, the operation time can be shortened. In this case, as a matter of course, metalized film raw material 20 does not need to be wound once before protective agent 8 is applied.

S4A: winding of metalized film raw material

In step S4A, metalized film raw material 20 is wound. Specifically, as illustrated in FIG. 5, metalized film raw material 20 is wound around axis J2 in circumferential direction θ2 in the evacuated chamber to obtain metalized film raw material wound body 20A.

In the flowchart illustrated in FIG. 6, the operation of step S4A is performed after the operation of step S3A. However, the method for manufacturing metalized film raw material wound body 20A according to the first exemplary embodiment includes concurrently performing the operations of step S3A and step S4A. That is, the method for manufacturing metalized film raw material wound body 20A according to the first exemplary embodiment includes applying protective agent 8 to metalized film raw material 20 while winding metalized film raw material 20 coated with protective agent 8. Thus, when the metalized film raw material 20 coated with protective agent 8 is wound without waiting for the completion of the entire operation of applying protective agent 8, the operation time can be shortened.

As described above, the method for manufacturing metalized film raw material wound body 20A according to the first exemplary embodiment includes concurrently performing the operations of step S2A and step S3A, and further includes concurrently performing the operations of step S3A and step S4A. That is, the method for manufacturing metalized film raw material wound body 20A according to the first exemplary embodiment includes concurrently performing all the operations of step S2A, step S3A, and step S4A.

### Effects

According to the method for manufacturing metalized film raw material wound body 20A of the first exemplary embodiment, metalized film raw material wound body 20A that makes atmospheric air and moisture hardly enter in the inside thereof can be obtained. This is because protective agent 8 functions as a breakwater in a sense. In metalized film raw material wound body 20A, it is considered that end surfaces 7 are entry paths of atmospheric air and moisture. In the first exemplary embodiment, protective agent 8 is placed in a spiral shape along circumferential direction θ2 near end surfaces 7 (left end surface 7a and right end surface 7b) of metalized film raw material wound body 20A. This makes it possible to prevent atmospheric air and moisture from entering the inside of metalized film raw material wound body 20A.

If protective agent 8 is not present, the atmospheric air and moisture rapidly enter from the end surfaces 7 of metalized film raw material wound body 20A when the evacuated state inside the chamber is returned to the normal pressure state. Accordingly, oxidation of the end portions is likely to progress as compared with the inside of metalized film raw material wound body 20A. In this way, metal films 40 are unevenly oxidized. For example, in FIG. 4, metal film 40 of first pattern region F₁and metal film 40 of n-th pattern region Fₙ are likely to be oxidized, and metal film 40 of fourth pattern region F₄and metal film 40 of (n-3)-th pattern region Fₙ₋₃ are hardly oxidized.

In contrast, in the first exemplary embodiment, since protective agent 8 is present, it is possible to prevent rapid atmospheric air and moisture from entering and to promote uniform natural oxidation. For example, in FIG. 4, metal films 40 from first pattern region F₁ to n-th pattern region Fₙ are uniformly naturally oxidized. Therefore, quality of the plurality (n) of metalized films 2 becomes uniform.

Accordingly, variations in quality such as electrostatic capacity can be reduced in film capacitor 1 manufactured using metalized film raw material wound body 20A according to the first exemplary embodiment.

### 1.3 Film capacitor

Next, film capacitor 1 according to a first exemplary embodiment will be described with reference to FIGS. 1-4. Film capacitor 1 according to the first exemplary embodiment includes first metalized film 21 and second metalized film 22. Film capacitor 1 further includes end-face electrodes 400.

As will be described in the section of "(1.4) Method for Manufacturing Film Capacitor" described later, first metalized film 21 and second metalized film 22 are any two metalized films 2 selected from plurality (n) of metalized films 2 obtained from metalized film raw material wound body 20A.

As illustrated in FIG. 1, first metalized film 21 and second metalized film 22 face each other in the up-and-down direction.

First metalized film

First metalized film 21 includes first dielectric film 31, first metal film 41, and first natural oxide film 51.

First dielectric film

First dielectric film 31 corresponds to dielectric film raw material 30 of p-th pattern region Fₚ in metalized film raw material 20 (p is an integer of 1 or more and n or less). Therefore, the material and thickness of first dielectric film 31 are the same as the material and thickness of dielectric film raw material 30.

First metal film

First metal film 41 corresponds to metal film 40 of p-th pattern region Fₚ in metalized film raw material 20. Therefore, the material and thickness of first metal film 41 are the same as the material and thickness of metal film 40.

First metal film 41 is disposed on first dielectric film 31. In FIG. 1, first metal film 41 is directly disposed on the upper surface of first dielectric film 31.

In the width direction of first dielectric film 31, first margin 301 is disposed adjacent to the right side of first metal film 41. First margin 301 corresponds to margin 300 of p-th pattern region Fₚ in metalized film raw material 20. The first margin 301 is a portion where first metal film 41 is not disposed, and is a portion where first dielectric film 31 is exposed. The first margin 301 extends in the front-rear direction.

First natural oxide film

First natural oxide film 51 is disposed on first metal film 41. First natural oxide film 51 is a thin film of oxide naturally formed when the surface layer of first metal film 41 is exposed to the atmospheric air.

Second metalized film

Second metalized film 22 includes second dielectric film 32, second metal film 42, and second natural oxide film 52.

Second dielectric film

Second dielectric film 32 corresponds to dielectric film raw material 30 of q-th pattern region F_{q}in metalized film raw material 20 (q is an integer between 1 and n, and q ≠ p). Therefore, the material and thickness of the second dielectric film 32 are also the same as the material and thickness of dielectric film raw material 30.

Second metal film

Second metal film 42 corresponds to metal film 40 of q-th pattern region F_{q}in metalized film raw material 20. Therefore, the material and thickness of second metal film 42 are also the same as the material and thickness of metal film 40.

The second metal film 42 is disposed on the second dielectric film 32. In FIG. 1, second metal film 42 is directly disposed on the upper surface of the second dielectric film 32.

In the width direction of second dielectric film 32, second margin 302 is disposed adjacent to the left side of second metal film 42. Second margin 302 corresponds to margin 300 of q-th pattern region F_{q} in metalized film raw material 20. The second margin 302 is a portion where second metal film 42 is not disposed, and is a portion where the second dielectric film 32 is exposed. The second margin 302 also extends in the front-rear direction.

Second natural oxide film

Second natural oxide film 52 is disposed on second metal film 42. Second natural oxide film 52 is a thin film of oxide naturally formed when the surface layer of second metal film 42 is exposed to the atmospheric air.

As described above, first natural oxide film 51 and second natural oxide film 52 are formed spontaneously without special treatment. Therefore, the thickness of first natural oxide film 51 is equal to the thickness of second natural oxide film 52.

End-face electrode

In the first exemplary embodiment, the end-face electrode 400 includes a first end-face electrode 401 and a second end-face electrode 402. The first end-face electrode 401 is connected to first metal film 41, but is not connected to second metal film 42. On the other hand, the second end-face electrode 402 is connected to second metal film 42, but is not connected to first metal film 41.

The metal constituting the end-face electrode 400 is not particularly limited, and examples thereof include zinc (Zn), tin (Sn), and alloys thereof.

### Effects

Film capacitor 1 according to the first exemplary embodiment is manufactured using metalized film raw material wound body 20A. As described above, the quality of the plurality (n) of metalized films 2 becomes uniform in metalized film raw material wound body 20A. Therefore, the variation in the thickness of dielectric film 3 and natural oxide film 5, which are sandwiched between first metal film 41 and second metal film 42, is reduced

Therefore, according to film capacitor 1 of the first exemplary embodiment, local electric field concentration can be suppressed, and reliability can be enhanced.

### 1.4 Method for manufacturing film capacitor

Next, a method for manufacturing film capacitor 1 according to the first exemplary embodiment will be described with reference to FIGS. 1-4. The method for manufacturing film capacitor 1 includes step S5 and step S6. The method for manufacturing film capacitor 1 may further include step S7.

S5: dividing step

In step S5, metalized film raw material 20 is divided to obtain plurality of metalized films 2. That is, metalized film raw material 20 in metalized film raw material wound body 20A is divided for each metal film 40 having the predetermined pattern to obtain plurality of metalized films 2. That is, when metalized film raw material 20 illustrated in FIG. 4 is cut and divided at a boundary line indicated by a two-dot chain line, plurality (n) of metalized films 2 and end regions 6 are obtained. Since end regions 6 are unnecessary for manufacturing film capacitor 1, they are removed.

S6: winding step

In step S6, a pair of metalized films 2 among the plurality of metalized films 2 are overlapped and wound.

The pair of metalized films 2 are first metalized film 21 and second metalized film 22. First metalized film 21 and second metalized film 22 are any two metalized films 2 selected from plurality (n) of metalized films 2 obtained from metalized film raw material 20.

In the first exemplary embodiment, as illustrated in FIG. 2, first metalized film 21 and second metalized film 22 are overlapped and wound in circumferential direction θ1 around axis J1 to obtain cylindrical wound body 10. When the cylindrical wound body 10 is pressurized in one direction perpendicular to the axis J1, the flattened wound body 10 having an oblate cylindrical shape is obtained (see FIG. 3). Wound body 10 may remain in a cylindrical shape.

S7: thermal spraying step

In step S7, end-face electrodes 400 are formed by thermal-spraying metal on the end surfaces of wound body 10. Specifically, the first end-face electrode 401 is formed by thermal spraying metal onto one end (one end surface in the direction of the axis J1) of wound body 10. On the other hand, the second end-face electrode 402 is formed by thermal spraying metal to the other end (the other end surface in the direction of the axis J1) of wound body 10.

When step S7 is completed, film capacitor 1 as illustrated in FIG. 3 is obtained.

### Effects

The method for manufacturing film capacitor 1 according to the first exemplary embodiment uses metalized film raw material wound body 20A. As described above, the quality of the plurality (n) of metalized films 2 becomes uniform in metalized film raw material wound body 20A.

Therefore, in film capacitor 1 obtained by the method for manufacturing film capacitor 1 according to the first exemplary embodiment, the variation in the thickness of dielectric film 3 and natural oxide film 5, which are sandwiched between first metal film 41 and second metal film 42, is reduced.

Therefore, according to the method for manufacturing film capacitor 1 according to the first exemplary embodiment, it is possible to manufacture film capacitor 1 with high reliability in which local electric field concentration is suppressed.

### 2 Second exemplary embodiment

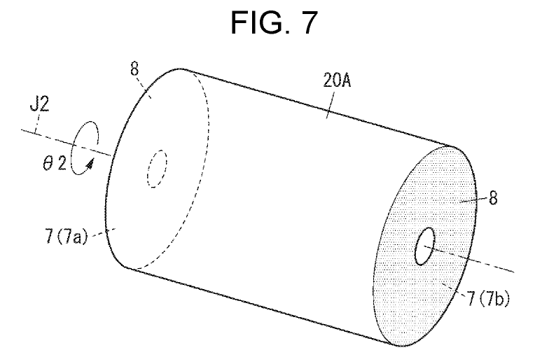

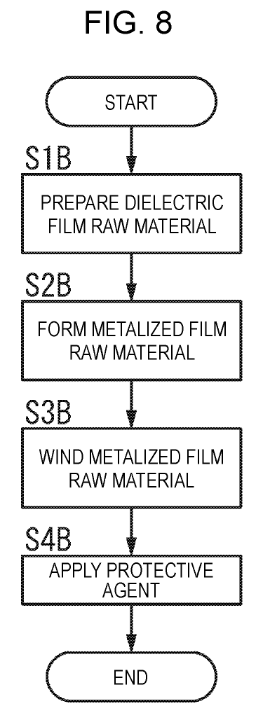

Next, metalized film raw material wound body 20A according to a second exemplary embodiment and a method for manufacturing the same will be described with reference to FIGS. 7 and 8. In the second exemplary embodiment, components similar to those in the first exemplary embodiment are denoted by the same reference numerals and characters as those in the first exemplary embodiment, and details of the components may not be described.

### 2.1 Metalized film raw material wound body

In the second exemplary embodiment, protective agent 8 is not applied to end regions 6 of metalized film raw material 20. Instead, as illustrated in FIG. 7, protective agent 8 is applied to both side end surfaces or one side end surface (here, both side end surfaces) of metalized film raw material wound body 20A. Specifically, protective agent 8 is applied to left end surface 7a and right end surface 7b of metalized film raw material wound body 20A. In the second exemplary embodiment, protective agent 8 may be applied to end regions 6 of metalized film raw material 20.

### Effects

The second exemplary embodiment also achieves effects similar to those in the first exemplary embodiment.

Particularly, in the second exemplary embodiment, protective agent 8 is disposed on end surfaces 7 (left end surface 7a and right end surface 7b) of metalized film raw material wound body 20A. This makes it possible to prevent atmospheric air and moisture from entering the inside of metalized film raw material wound body 20A.

Accordingly, film capacitor 1 manufactured using metalized film raw material wound body 20A according to the second exemplary embodiment can reduce variations in quality such as electrostatic capacity.

### 2.2 Method for manufacturing metalized film raw material wound body

Next, a method for manufacturing metalized film raw material wound body 20A according to the second exemplary embodiment will be described with reference to FIGS. 7 and 8.

As illustrated in FIG. 8, the method for manufacturing metalized film raw material wound body 20A includes step S1B, step S2B, step S3B, and step S4B. A series of operations from at least step S1B to step S3B can be performed in a chamber. If technically possible, the operation of step S4B is also preferably performed in the chamber.

S1B: preparation of dielectric film raw material

Step S1B is the same as step S1A of the first exemplary embodiment.

S2B: formation of metalized film raw material

Step S2B is the same as step S2A of the first exemplary embodiment.

S3B: winding of metalized film raw material

Step S3B is substantially the same as step S4A of the first exemplary embodiment. However, protective agent 8 is not applied to end regions 6 of metalized film raw material 20 wound in step S3B.

S4B: application of protective agent

In step S4B, protective agent 8 is applied to metalized film raw material wound body 20A. That is, protective agent 8 is applied to both side end surfaces or one side end surface (here, both side end surfaces) of metalized film raw material wound body 20A. Specifically, protective agent 8 is applied to left end surface 7a and right end surface 7b of metalized film raw material wound body 20A to obtain metalized film raw material wound body 20A as illustrated in FIG. 7. Preferably, protective agent 8 is applied as soon as possible after metalized film raw material wound body 20A is taken out from the chamber.

### Effects

The second exemplary embodiment also achieves effects similar to those in the first exemplary embodiment.

Particularly, in the second exemplary embodiment, protective agent 8 is placed on end surfaces 7 (left end surface 7a and right end surface 7b) of metalized film raw material wound body 20A. This makes it possible to prevent atmospheric air and moisture from entering the inside of metalized film raw material wound body 20A.

Accordingly, film capacitor 1 manufactured using metalized film raw material wound body 20A according to the second exemplary embodiment can reduce variations in quality such as electrostatic capacity.

### 2.3 Film capacitor and method for manufacturing the same

Film capacitor 1 and the method for manufacturing the same according to the second exemplary embodiment are common to film capacitor 1 and the method for manufacturing the same according to the first exemplary embodiment, and thus detailed description thereof is omitted.

### 3 Third exemplary embodiment

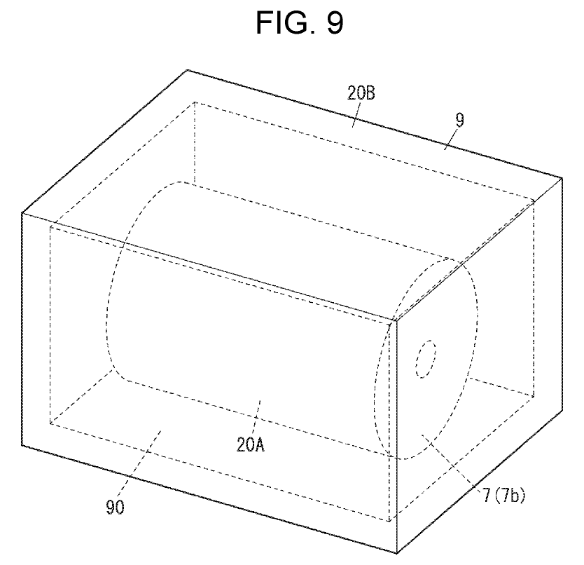

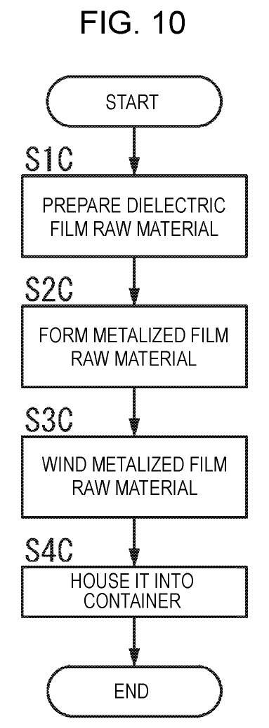

Next, a container-enclosed metalized film raw material wound body 20B according to a third exemplary embodiment and a method for manufacturing the same will be described with reference to FIGS. 9 and 10. In the third exemplary embodiment, components similar to those in the first to second exemplary embodiments are denoted by the same reference numerals and characters as those in the first and second exemplary embodiments, and a detailed description thereof may be omitted.

### 3.1 Container-enclosed metalized film raw material wound body

Container-enclosed metalized film raw material wound body 20B includes metalized film raw material wound body 20A and container 9.

Metalized film raw material wound body

In the third exemplary embodiment, protective agent 8 is not applied to end regions 6 of metalized film raw material 20. Furthermore, protective agent 8 is not applied to end surfaces 7 of metalized film raw material wound body 20A. Instead, in the third exemplary embodiment, container 9 is used as described later. Also in the third exemplary embodiment, protective agent 8 may be applied to end regions 6 of metalized film raw material 20, or protective agent 8 may be applied to end surfaces 7 of metalized film raw material wound body 20A.

### Container

Container 9 houses metalized film raw material wound body 20A. Container 9 includes storage space 90 and is configured to be able to open and close. Metalized film raw material wound body 20A is housed in storage space 90. At this time, a desiccant and/or a deoxidizer may be housed in storage space 90 together with metalized film raw material wound body 20A.

The desiccant absorbs moisture in the storage space 90. The desiccant is not particularly limited, and examples thereof include silica gel, calcium chloride, calcium oxide, and molecular sieve.

The deoxidizer absorbs oxygen in the storage space 90. The deoxidizer is not particularly limited, and examples thereof include an iron powder-based deoxidizer.

The material of container 9 may be made of resin or metal, and is not particularly limited as long as it hardly transmits atmospheric air and moisture.

### Effects

The third exemplary embodiment also achieves effects similar to those in the first exemplary embodiment.

In particular, in the third exemplary embodiment, metalized film raw material wound body 20A is housed in container 9. Moreover, desiccant and deoxidizer may be housed together in container 9. This makes it possible to prevent atmospheric air and moisture from entering the inside of metalized film raw material wound body 20A.

Accordingly, variations in quality such as electrostatic capacity can be reduced in film capacitor 1 manufactured by using container-enclosed metalized film raw material wound body 20B according to the third exemplary embodiment.

### 3.2 Method for manufacturing container-enclosed metalized film raw material wound body

Next, a method for manufacturing container-enclosed metalized film raw material wound body 20B according to the third exemplary embodiment will be described with reference to FIGS. 9 and 10.

As illustrated in FIG. 10, the method for manufacturing container-enclosed metalized film raw material wound body 20B includes step S1C, step S2C, step S3C, and step S4C. A series of operations from step S1C to step S3C can be performed in a chamber.

S1C: preparation of dielectric film raw material

Step S1C is the same as step S1A of the first exemplary embodiment.

S2C: formation of metalized film raw material

Step S2C is the same as step S2A of the first exemplary embodiment.

S3C: winding of metalized film raw material

Step S3C is substantially the same as step S4A of the first exemplary embodiment. However, protective agent 8 is not applied to end regions 6 of metalized film raw material 20 wound in step S3C. Furthermore, protective agent 8 is not applied to end surfaces 7 of wound metalized film raw material wound body 20A.

S4C: housing into container

In step S4C, metalized film raw material wound body 20A is housed into container 9. In this way, container-enclosed metalized film raw material wound body 20B as illustrated in FIG. 9 is obtained. Metalized film raw material wound body 20A is preferably housed into container 9 as soon as possible after metalized film raw material wound body 20A is taken out from the chamber.

### Effects

The third exemplary embodiment also achieves effects similar to those in the first exemplary embodiment.

In particular, in the third exemplary embodiment, metalized film raw material wound body 20A is housed in container 9. Moreover, desiccant and deoxidizer may be housed together in container 9. This makes it possible to prevent atmospheric air and moisture from entering the inside of metalized film raw material wound body 20A.

Accordingly, variations in quality such as electrostatic capacity can be reduced in film capacitor 1 manufactured by using container-enclosed metalized film raw material wound body 20B according to the third exemplary embodiment.

### 3.3 Film capacitor and method for manufacturing the same

Film capacitor 1 and the method for manufacturing the same according to the third embodiment are common to film capacitor 1 and the method for manufacturing the same according to the first exemplary embodiment, and thus detailed description thereof is omitted. Needless to say, in the third exemplary embodiment, metalized film raw material wound body 20A in which metalized film raw material 20 is wound is taken out from container 9 and used for manufacturing film capacitor 1.

### 3. Modified examples

The first to third exemplary embodiments may be appropriately combined.

For example, the first exemplary embodiment and the second exemplary embodiment can be combined. Specifically, protective agent 8 may be applied to end surfaces 7 of metalized film raw material wound body 20A according to the first exemplary embodiment.

The first exemplary embodiment and the third exemplary embodiment can also be combined. Specifically, metalized film raw material wound body 20A according to the first exemplary embodiment may be housed in container 9.

The second exemplary embodiment and the third exemplary embodiment can also be combined. Specifically, metalized film raw material wound body 20A according to the second exemplary embodiment may be housed in container 9.

In the third exemplary embodiment, a bag may be used instead of container 9. Container 9 and the bag are common because container 9 and the bag can house and seal metalized film raw material wound body 20A.

### 4. Aspects

As is apparent from the above exemplary embodiments and modified examples, the present disclosure includes aspects below. Hereinafter, reference numerals and characters are given in parentheses only to clarify a correspondence relationship with the exemplary embodiments.

A first aspect is film capacitor (1) including first metalized film (21) and second metalized film (22). First metalized film (21) includes first dielectric film (31), first metal film (41) disposed on first dielectric film (31), and first natural oxide film (51) disposed on first metal film (41). Second metalized film (22) includes second dielectric film (32), second metal film (42) disposed on second dielectric film (32), and second natural oxide film (52) disposed on second metal film (42). The thickness of first natural oxide film (51) is equal to the thickness of second natural oxide film (52).

According to this aspect, local electric field concentration can be supressed, and reliability can be enhanced.

A second aspect is metalized film raw material wound body (20A) that includes metalized film raw material (20) having a strip shape and being wound to form metalized film raw material wound body (20A). Metalized film raw material (20) includes dielectric film raw material (30) having a strip shape and plurality of metal films (40) disposed on dielectric film raw material (30) to be arranged side by side in a width direction of dielectric film raw material (30), plurality of metal films (40) each having a predetermined pattern. Protective agent (8) is applied to both side parts or one side part of an entirety of the plurality of metal films (40) each having the predetermined pattern in the width direction of metalized film raw material (20).

According to this aspect, it is possible to reduce variations in quality such as electrostatic capacity.

A third aspect is metalized film raw material wound body (20A) that includes metalized film raw material (20) having a strip shape and being wound to form metalized film raw material wound body (20A). Metalized film raw material (20) includes dielectric film raw material (30) having a strip shape and plurality of metal films (40) disposed on dielectric film raw material (30) to be arranged side by side in a width direction of dielectric film raw material (30), plurality of metal films (40) each having a predetermined pattern. Protective agent (8) is applied to both side end surfaces or one side end surface of metalized film raw material wound body (20A).

According to this aspect, it is possible to reduce variations in quality such as electrostatic capacity.

A fourth aspect is container-enclosed metalized film raw material wound body (20B) that includes: metalized film raw material wound body (20A) that includes metalized film raw material (20) having a strip shape and being wound to form metalized film raw material wound body (20A); and container (9) that houses metalized film raw material wound body (20A). Metalized film raw material (20) includes dielectric film raw material (30) having a strip shape and plurality of metal films (40) disposed on dielectric film raw material (30) to be arranged side by side in a width direction of dielectric film raw material (30), plurality of metal films (40) each having a predetermined pattern.

According to this aspect, it is possible to reduce variations in quality such as electrostatic capacity.

A fifth aspect is a method for manufacturing metalized film raw material wound body (20A), the method including: a step of preparing dielectric film raw material (30) having a strip shape; a step of forming metalized film raw material (20) by disposing plurality of metal films (40) each having a predetermined pattern on one surface or both surfaces of dielectric film raw material (30), the plurality of metal films (40) being arranged side by side in a width direction of dielectric film raw material (30); a step of applying protective agent (8) to both side parts or one side part of an entirety of the plurality of metal films (40) each having the predetermined pattern in the width direction of metalized film raw material (20); and a step of winding metalized film raw material (20).

According to this aspect, it is possible to reduce variations in quality such as electrostatic capacity.

A sixth aspect is a method for manufacturing metalized film raw material wound body (20A), the method including: a step of preparing dielectric film raw material (30) having a strip shape; a step of forming metalized film raw material (20) by disposing plurality of metal films (40) each having a predetermined pattern on one surface or both surfaces of dielectric film raw material (30), the plurality of metal films (40) being arranged side by side in a width direction of dielectric film raw material (30); a step of winding metalized film raw material (20) to obtain metalized film raw material wound body (20A); and a step of applying protective agent (8) to both side end surfaces or one side end surface of metalized film raw material wound body (20A).

According to this aspect, it is possible to reduce variations in quality such as electrostatic capacity.

A seventh aspect is a method for manufacturing container-enclosed metalized film raw material wound body (20B), the method including: a step of preparing dielectric film raw material (30) having a strip shape; a step of forming metalized film raw material (20) by disposing plurality of metal films (40) each having a predetermined pattern on one surface or both surfaces of dielectric film raw material (30), the plurality of metal films (40) being arranged side by side in a width direction of dielectric film raw material (30); a step of winding metalized film raw material (20) to obtain metalized film raw material wound body (20A); and a step of housing metalized film raw material wound body (20A) in container (9).

According to this aspect, it is possible to reduce variations in quality such as electrostatic capacity.

An eighth aspect is a method for manufacturing film capacitor (1), the method including: a step of obtaining plurality of metalized films (2) by dividing metalized film raw material (20) for each of the plurality of metal films (40) each having the predetermined pattern, metalized film raw material (20) being included in metalized film raw material wound body (20A) according to the second or third aspect or container-enclosed metalized film raw material wound body (20B) according to the fourth aspect; and a step of winding a pair of metalized films (2) among the plurality of metalized films (2) so that the pair of metalized films (2) overlap each other.

According to this aspect, it is possible to manufacture highly reliable film capacitor (1) in which local electric field concentration is suppressed.

What is claimed is:

1. A film capacitor comprising:
a first metalized film; and
a second metalized film, wherein:
the first metalized film includes a first dielectric film, a first metal film disposed on the first dielectric film, and a first natural oxide film disposed on the first metal film,
the second metalized film includes a second dielectric film, a second metal film disposed on the second dielectric film, and a second natural oxide film disposed on the second metal film, and
a thickness of the first natural oxide film is equal to a thickness of the second natural oxide film.

2. A metalized film raw material wound body comprising a metalized film raw material having a strip shape, the metalized film raw material being wound to form the metalized film raw material wound body, wherein:
the metalized film raw material includes
a dielectric film raw material having a strip shape and
a plurality of metal films disposed on the dielectric film raw material to be arranged side by side in a width direction of the dielectric film raw material, the plurality of metal films each having a predetermined pattern, and
a protective agent is applied to both side parts or one side part of an entirety of the plurality of metal films each having the predetermined pattern in the width direction of the metalized film raw material.

3. A metalized film raw material wound body comprising a metalized film raw material having a strip shape, the metalized film raw material being wound to form the metalized film raw material wound body, wherein:
the metalized film raw material includes
a dielectric film raw material having a strip shape and
a plurality of metal films disposed on the dielectric film raw material to be arranged side by side in a width direction of the dielectric film raw material, the plurality of metal films each having a predetermined pattern, and
a protective agent is applied to both side end surfaces or one side end surface of the metalized film raw material wound body.

4. A container-enclosed metalized film raw material wound body comprising:
a metalized film raw material wound body including a metalized film raw material having a strip shape, the metalized film raw material being wound to form the metalized film raw material wound body; and
a container that houses the metalized film raw material wound body, wherein:
the metalized film raw material includes
a dielectric film raw material having a strip shape and
a plurality of metal films disposed on the dielectric film raw material to be arranged side by side in a width direction of the dielectric film raw material, the plurality of metal films each having a predetermined pattern.

5. A method for manufacturing a metalized film raw material wound body, the method comprising:
a step of preparing a dielectric film raw material having a strip shape;
a step of forming a metalized film raw material by disposing a plurality of metal films each having a predetermined pattern on one surface or both surfaces of the dielectric film raw material, the plurality of metal films being arranged side by side in a width direction of the dielectric film raw material;
a step of applying a protective agent to both side parts or one side part of an entirety of the plurality of metal films each having the predetermined pattern in the width direction of the metalized film raw material; and
a step of winding the metalized film raw material.

6. A method for manufacturing a metalized film raw material wound body, the method comprising:
a step of preparing a dielectric film raw material having a strip shape;
a step of forming a metalized film raw material by disposing a plurality of metal films each having a predetermined pattern on one surface or both surfaces of the dielectric film raw material, the plurality of metal films being arranged side by side in a width direction of the dielectric film raw material;
a step of winding the metalized film raw material to obtain a metalized film raw material wound body; and
a step of applying a protective agent to both side end surfaces or one side end surface of the metalized film raw material wound body.

7. A method for manufacturing a container-enclosed metalized film raw material wound body, the method comprising:
a step of preparing a dielectric film raw material having a strip shape;
a step of forming a metalized film raw material by disposing a plurality of metal films each having a predetermined pattern on one surface or both surfaces of the dielectric film raw material, the plurality of metal films being arranged side by side in a width direction of the dielectric film raw material;
a step of winding the metalized film raw material to obtain a metalized film raw material wound body; and
a step of housing the metalized film raw material wound body in a container.

8. A method for manufacturing a film capacitor, the method comprising:
a step of obtaining a plurality of metalized films by dividing the metalized film raw material for each of the plurality of metal films each having the predetermined pattern, the metalized film raw material being included in the metalized film raw material wound body according to claim 2; and
a step of winding a pair of metalized films among the plurality of metalized films so that the pair of metalized films overlap each other.

9. A method for manufacturing a film capacitor, the method comprising:
a step of obtaining a plurality of metalized films by dividing the metalized film raw material for each of the plurality of metal films each having the predetermined pattern, the metalized film raw material being included in the metalized film raw material wound body according to claim 3; and
a step of winding a pair of metalized films among the plurality of metalized films so that the pair of metalized films overlap each other.

10. A method for manufacturing a film capacitor, the method comprising:
a step of obtaining a plurality of metalized films by dividing the metalized film raw material for each of the plurality of metal films each having the predetermined pattern, the metalized film raw material being included in the container-enclosed metalized film raw material wound body according to claim 4; and
a step of winding a pair of metalized films among the plurality of metalized films so that the pair of metalized films overlap each other.
